(19) United States
(12) Patent Application Publication
(10) Pub. No.: US 2008/0283792 A1
(43) Pub. Date: Nov. 20, 2008

(54) Separation Medium with Various Functionalities

(75) Inventors: Andreas Axen, Uppsala (SE); Eva Holmgren, Uppsala (SE); Nils Norrman, Uppsala (SE); Tobias Soderman, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, UPPSALA (SE)

(21) Appl. No.: 12/090,403

(22) PCT Filed: Oct. 23, 2006
(86) PCT No.: PCT/SE06/01196

§ 371 Date: Apr. 16, 2008

(30) Foreign Application Priority Data
Oct. 28, 2005 (SE) 0502405-4

(51) Int. Cl. B03C 1/01

(52) U.S. Cl. 252/62.54

(57) ABSTRACT

The present invention relates to a separation medium with various functionalities suitable for, for example, isolation of proteins, cells, and viruses and also for diagnostic applications and cell cultivation. The separation medium comprises magnetic metal particles, preferably coated with an inert synthetic polymer, and pre-functionalised beads. These particles and beads are provided encapsulated in a hydrophilic porous polymer, preferably agarose. The beads may be used for cell cultivation or for chromatography. When the beads are used for chromatography the agarose layer may be provided with ligands having affinity for selected biomolecules.

### FIELD OF THE INVENTION

The present invention relates to a separation medium with various functionalities useful e.g. in chromatography and filtration. The separation medium comprises magnetic beads as well as pre-functionalised beads. The separation medium is suitable for, for example, isolation of proteins, cells, and viruses and also for diagnostic applications and cell cultivation.

### BACKGROUND OF THE INVENTION

Separation media, such as chromatography media and filtration media, are often associated with non-satisfactory properties to some end. Important factors in this field are e.g. the mass transport properties of the media, the flow properties thereof when used in chromatography columns or as membranes, cumbersome and non-reliable methods of preparation etc. Hence, there is an ongoing development to seek improvements in this field.

Recently an increased number of products referred to as magnetic beads and a number of products for efficient handling of these products have been presented. Magnetic bead technologies are used for diverse purposes such as isolating nucleic acids and proteins as well as viruses and whole cells. The adaptability and speed of this technique makes it ideal for high-throughput applications e.g. in 96 wells micro titre plates. The techniques is also applicable for large scale applications, such as chromatography application in liquid magnetically stabilised fluidised beds or batch wise protocols.

The magnetic beads are most commonly used in combination with attached ligands having affinity for different substances. The most commonly encountered examples are metal chelating ligands (of IMAC type) intended for use in combination with His-tags and glutathione intended for use in combination with GST (Gluthathione S transferase). Other examples are a variety of different IgG's with different specificity.

Preparation of beads encapsulating metallic materials and applications of magnetic beads has been described previously. Preparing magnetic beads where the bead is built up of different layers of material has also been presented earlier.

U.S. Pat. No. 5,834,121 describes composite magnetic beads. Polymer coated metal oxide particles that are encapsulated in a rigid and solvent stable polymer of vinyl monomers in order to retain the metal oxide particles during harsh conditions. The primary beads are enclosed in a micro porous polymer bead which is capable of swelling in organic solvents and allowing for further functionalisation in order to be useful for organic synthesis. This procedure is aiming for hydrophobic beads.

U.S. Pat. No. 6,204,033 describes preparation of polyvinyl alcohol-based magnetic beads for binding biomolecules. Preparation of magnetic beads by polyvinyl alcohol in water containing magnetic particles. The final beads contain hydroxyl functionalities that can be further derivatized in order to couple biomolecules. It is claimed that these magnetic beads can be grafted with vinyl monomers carrying various functional groups.

U.S. Pat. No. 6,274,387 describes a magnetic carrier, preparation thereof, and a method of extraction of nucleic acid. Particulate silica containing magnetic material is covered with polyacryl amide.

EP 0179039 describes polymer coated metal surfaces. Dextran carrying imino diacetate groups are allowed to attach to a metal surface. Several rounds of activation and coupling of dextran is required to build up a particle. To the dextran various ligands can be attached.

In J. of Polymer Science: Part A: Polymer Chemistry p. 1342-1356, (2005), preparation and clinical application of immunomagnetic latex is described by Wang et al. Magnetic metal oxide particles were encapsulated in poly(methyl methacrylate) [PMMA]. In order to add —COOH functional groups to the surface, a core of poly(methyl methacrylate-co-methacrylic acid) [P(MMA-MAA)] was added.

In spite of the relatively large number of magnetic beads described today, there is still a need for separation media having various functionalities besides the magnetic properties.

### SUMMARY OF THE INVENTION

The present invention relates to a novel construction that provides a magnetic material and pre-functionalised beads in the same separation medium.

According to the present invention magnetic metal oxide particles are preferably coated in an inert synthetic polymer and subsequently these particles as well as pre-functionalised beads are provided with a porous outer layer, preferably in bead form. This construction provides magnetic beads with low risk of leakage of metal ions even at harsh conditions, as well as pre-functionalised beads for various applications. Both types of beads are combined in a hydrophilic, bio compatible and macro-porous outer layer, preferably made of agarose.

Thus, in a first aspect the present invention provides a separation medium, comprising magnetic metal particles and pre-functionalised beads encapsulated in an outer porous material.

Preferably, the magnetic metal particles comprise a coating of an inert synthetic polymer shell to form magnetic particles beads. At least one metal particle is present in each coated magnetic bead. This coating is preferably made of cross-linked polystyrene, poly(methacrylates) or polyacrylates.

The pre-functionalised beads are preferably ligand provided beads with a diameter below 50 μm. The ligand may be any ligands such as an affinity ligand or metal chelating ligands. Examples of beads are Mono Q™, Mono S™, Mono p™, Source 15Q™, Source 15S™,

The pre-functionalised beads are and the coated metal particles beads are joined in a common outer layer or bead. At least one coated metal particles bead and one pre-functionalised bead are enclosed in the outer layer/outer bead.

The pre-functionalised beads and the coated metal particles are encapsulated in an outer porous material preferably in such a way that new spherical beads are formed Each spherical bead comprises at least one coated metal particle and at least one functionalised bead, preferably 10-20 particles/beads.

In an alternative embodiment the separation medium comprises the above beads which are aggregated into hierarchical structures. A description on the forming of spherical aggregates and beads with hierarchical pore structure can be found in WO 04/056473 which is hereby incorporated by reference.

In a preferred embodiment the outer coating of the separation medium is made of a natural or synthetic hydrophilic polymer.

The outer coating is made of, e.g. agarose, dextran, cellulose, poly(vinyl alcohol) or polyacrylamides. The outer coating preferably form a bead shaped particle.

Hydrophilic properties are very important for obtaining biocompatibility, and prevention of unspecific interactions.

In a preferred separation medium the metal particles are made of Fe₃O₄, the coating of the metal particles is made of poly(divinylbenzene), the pre-functionalised beads are Source 15Q or Source 15S, and the outer coating is made of agarose. The separation medium is preferably in bead form.

The pore size of the bead construction is 1 nm-50 μm, preferably 50-500 nm.

The particle diameter of a beaded separation medium according to the invention is 5-10000 μm, preferably 20-400 μm, most preferably 50-150 μm.

The invention can be used in combination with a large variety of ligands. The ligands will be provided on the pre-functionalised beads and/or the outer coating and may for example be selected from the group consisting of metal chelating agents, antibodies, members of affinity pairs, aptamers, hybridisation probes, charged groups (suitable for ion exchange) or lipophilic groups (suitable for hydrophobic interaction, HIC). In this way, the present invention enables the provision of a multi-functional separation medium, with up to four different functionalities, i.e. the magnetic functionality; the functionality from the pre-functionalised bead, for example the Q- or S-functionality; the possible additional ligand functionality on the pre-functionalised bead; and the possible ligand on the outer porous coating.

In one embodiment the outer agarose layer is provided with ligands such as those mentioned above, and preferably metal chelating (IMAC) ligands.

In a second aspect, the invention relates to a method of producing separation medium as described above, comprising the following steps,

a) treating magnetic metal, metal oxide or alloy particles with an amphiphilic agent;
b) adding a polymerisable monomer and a radical initiator to the treated magnetic particles;
c) emulsifying the monomer/particle mixture in an aqueous phase and polymerising the monomer by increasing the temperature to obtain polymer-coated magnetic particles;
d) mixing the polymer-coated magnetic particles with pre-functionalised beads;
e) adding the mixture to a hydrophilic polymer;
f) emulsifying the polymer-coated magnetic particles and the pre-functionalised beads into the hydrophilic polymer; and optionally
g) attaching a ligand to the outer layer of the hydrophilic polymer, said ligand having affinity for a selected biomolecule.

Preferably, the magnetic metal oxide particles are Fe₃O₄, the chemically inert polymer is poly(divinylbenzene), the pre-functionalised beads are Source 15Q and the hydrophilic polymer is agarose.

In a third aspect, the invention provides use the above described separation medium for separating, concentrating or analysing a biomolecule, such as a peptide, protein, antibody, carbohydrate, nucleic acid, plasmid, virus or cell or a fraction of any of these.

The biomolecule may be of human, animal, bacterial, viral or recombinant origin.

The analysis may for example be for research or diagnostic purposes.

Another use of the separation medium is for cultivating cells, such as mammalian cells, including stem cells, or bacteria.

The separation medium described above may also be used for scavenging, i.e. as a scavanger medium removing any remaining portions of an inpurity in a desired material.

### DETAILED DESCRIPTION OF THE INVENTION

The present invention offers a convenient route, starting from readily available functionalised beads and magnetic materials, to a magnetic and multi-functional agarose bead with a medium size diameter of 5-1000 μm, preferably 20-400 μm, more preferably 50-150 μm having a pore size that offers potential for both fast kinetics and high capacity regarding biomolecule adsorption. This is advantageous as compared to several of the currently existing products for lab scale applications, and also offers the possibility to use the same type of media for large scale applications. In addition to these criteria, the beads are chemically stable with regard to metal leakage.

In co-pending SE 0500870-1 the present inventors describe that encapsulated magnetic materials can be introduced into hydrophilic, porous materials such as agarose. To avoid the problem of metal leakage the magnetic material is first covered or coated with a chemically stable material. In a preferred embodiment, the magnetic material is encapsulated in small cross-linked polystyrene beads that are used as core particles in the preparation of agarose beads.

In the present invention this approach has been combined with the simultaneous insertion of pre-functionalised beads into a porous material such as agarose. This results in a multi-functional separation medium that is chemically stable towards metal leakage and at the same time posses an outer layer that offers a suitable environment for e.g. protein and cell separations.

### BRIEF DESCRIPTION OF THE FIGURES

FIG. 1 shows poly(DVB)-particles with encapsulated magnetic beads; and

FIG. 2 shows agarose beads containing both Source 15Q beads and iron oxide powder containing DVD beads.

### EXPERIMENTAL PART

### Materials and Methods

### Example 1

### Synthesis of Agarose Beads Comprising Iron Oxide and Source 15Q

Iron oxide powder (<5 μm) and Source™ 15Q were mixed in a 4.5% agarose solution and an in oil emulsification was performed. The formed beads were chilled out yielding beads possessing both magnetic properties and the functionality of the Source™ 15Q material.

Agarose (0.67 g) was dissolved in water (15 mL) by heating at 95° C. for 20 min. Iron oxide powder (3.0 g) and drained Source™ 15Q (6.7 g) was added to the agarose solution. The suspension was cooled to 90° C. and added to ethylendichloride (30 ml) and ethyl cellulose (2.0 g) in an emulsification vessel. The emulsification vessel was equipped with a 35 mm blade stirrer. The speed of the stirrer was kept at 200 rpm and the temperature was kept at 60° C. After approximately 5 minutes the speed of the stirrer was increased to 400 rpm during 5 minutes and thereafter decreased to 150 rpm, maintaining the temperature at 60° C.

Thereafter the emulsion was cooled and the beads were allowed to gel. The beads were washed with water and ethanol and enriched using a magnet. From the procedure 26 ml of magnetic particles were obtained, containing iron oxide powder and Source™ 15Q.

The outer agarose layer is also suited for further derivatisation with any desirable ligand that fulfils the needs for the intended application. Such applications can be protein, nucleic acid, virus or cell separation/concentration or any diagnostic application.

### Example 2

### a) Synthesis of Magnetic poly(divinyl benzene) Beads

5 g of iron oxide powder (particle size <5 μm) is added to 50 mL of oleic acid in an Ehrlenmeyer flask. The flask is left on a shaking table at room temperature for an hour. The iron oxide is allowed to sediment, and as much as possible of the oleic acid is removed by decantation.

0.4 g 2,2′-azobis(2-methylbutyronitrile) (AMBN) is dissolved in 20 g divinyl benzene (DVB), tech. 80%, and after complete dissolution of the initiator, the iron oxide particles are added. A 4% Methocel K-100 (w/v) solution is prepared in advance.

85 g of the methocel solution is added to a 250 mL three-necked round-bottom flask, followed by the organic phase prepared as above. The stirring speed is set at 175 rpm. After 30 minutes the reactor is immersed in an oil bath set at 70 degrees, and the polymerisation reaction is left overnight.

The product particles are sedimented a number of times in water, to remove fines. The particles are then washed on a glass filter with water, 5 M HCl and ethanol. No yellow colour (indicating iron leakage) was observed during the acid wash.

According to the invention, the method used for the preparation of magnetic poly(divinyl benzene) beads is suspension polymerisation. An important step in the preparation is that the magnetic entity, such as iron oxide powder, is pre-treated with an amphiphilic agent, such as oleic acid, which will render the material more hydrophobic so as to be dispersable in the divinyl benzene phase during synthesis.

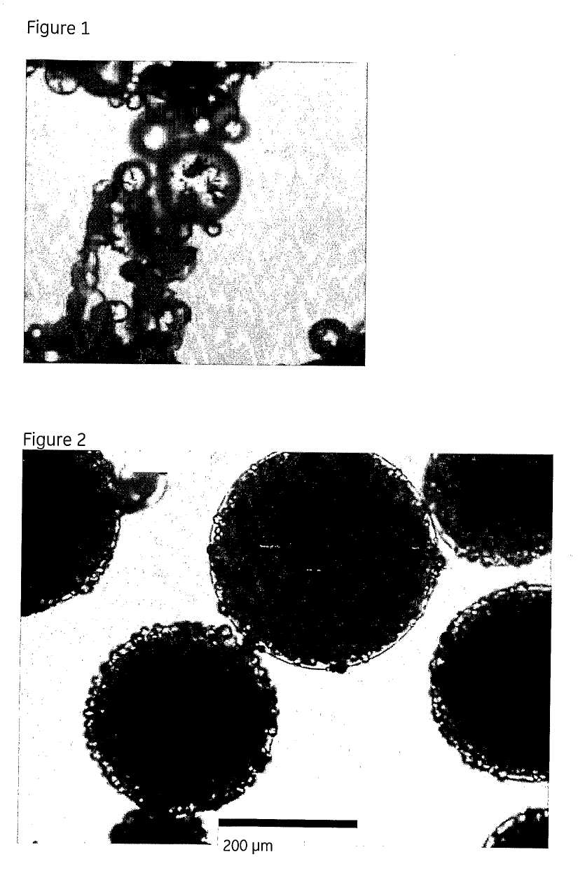

This synthesis method uses emulsification of an oil-in-water suspension. This method results in a highly magnetically active material where the magnetite (Fe₃O₄) particles, are encapsulated within the bead (FIG. 1). This means that the risk of leakage at acid pH is minimised, since the poly(divinyl benzene) is chemically inert at all pH commonly used in chromatography (pH 1-14). This material is suited as the basis for further coating with a hydrophilic polymer, e.g. agarose or a hydrophilic synthetic polymer, resulting in a magnetic material encapsulated in the chemically stable poly(DVB)-material and with an external hydrophilic layer (FIG. 2).

### 2b) Encapsulation of Magnetic DVB Beads and Pre-Functionalised Beads (Source 15Q™) in Agarose

Magnetic DVB beads and functionalized beads (Source™ 15Q) were mixed in a 4.5% agarose solution and an in oil emulsification was performed. The formed beads were chilled out yielding beads possessing both magnetic properties and the functionality of the Source 15 Q material.

Agarose (0.45 g) was dissolved in water (10 mL) by heating at 95° C. for 20 min. Drained magnetic DVB beads (1.34 g) and drained Source™ 15Q (4.5 g) was added to the agarose solution. The suspension was added to ethylendichloride (20 ml) and ethyl cellulose (1.34 g) in an emulsification vessel. The emulsification vessel was equipped with a 35 mm blade stirrer. The speed of the stirrer was kept at 200 rpm and the temperature was kept at 60° C. After approximately 5 minutes the speed of the stirrer was increased to 400 rpm during 3 minutes and thereafter decreased to 150 rpm, maintaining the temperature at 60° C.

Thereafter the emulsion was cooled and the beads were allowed to gel. The beads were washed with water and ethanol and enriched using a magnet. From the procedure 13 ml of magnetic particles were obtained, containing magnetic DVB beads and Source 15Q.

The outer agarose layer is also suited for further derivatisation with any desirable ligand that fulfils the needs for the intended application. Such applications can be protein, nucleic acid, virus or cell separation/concentration or any diagnostic application.

### Example 3

### Purification of His-Tagged Protein

0.5 mL of a 10% solution of aggregate beads containing beads pre-functionalised with a metal chelating ligand and beads with magnetic properties is transferred into an Eppendorf tube. The beads are pulled to the side of the tube with a permanent magnet. The solvent is removed and the beads are washed with buffer A tree times (the beads are pulled to the side of the tube to be able to remove the solvent between the washing). To the beads is added 1 mL of binding buffer C and 300 μL of a solution containing hexaHis-tagged green fluorescent protein (GFP) in a mixture with other molecules. The tube is turned for 45 min at ambient temperature. The beads are pulled to the side of the tube with a permanent magnet and the solvent is removed. The beads are washed with buffer A three times. The elution buffer B (1 mL) is added to the tube and it is turned for 5 min. The beads are pulled to the side of the tube with a permanent magnet and the solution, now containing the released and purified hexaHis-tagged GFP material can be used for further analysis.

Buffer A: 20 mM Na₂PO₃, 0.5 M NaCl, pH 7.

Buffer B: 500 mM imidazole, 20 mM Na₂PO₃, 0.5 M NaCl, pH 7.4

Buffer C: 20 mM imidazole, 20 mM Na₂PO₃, 0.5 M NaCl, pH 7.4

The multi-functional separation medium according to the invention may be used for column chromatography, chromatography in fluidised beds, batch-wise procedures, protein arrays on solid phase or in solution, high throughput analysis, filtration etc. The beads according to the invention are also suitable for cell cultivating purposes.

1: A separation medium, comprising magnetic metal particles having a coating of an inert synthetic polymer shell; and pre-functionalised beads, wherein both the coated metal particles and the pre-functionalised beads are encapsulated in an outer porous material.

2: The separation medium of claim 1, wherein the coating of the metal particles is made of cross linked polystyrene, poly(methacrylates) or polyacrylates.

3: The separation medium of claim 1, wherein the pre-functionalised beads are ligand provided beads with a diameter below 50 μm.

4: The separation medium of claim 1, wherein the outer coating is made of a natural or synthetic hydrophilic polymer.

5: The separation medium of claim 4, wherein the outer coating is made of agarose, dextran, cellulose, poly(vinyl alcohol) or polyacrylamides.

6: The separation medium of claim 1, wherein the pre-functionalised beads and the coated metal particles are encapsulated in an outer porous material in such a way that new spherical beads are formed.

7: The separation medium of claim 6, wherein each spherical bead comprises at least one coated metal particle and at least one functionalised bead.

8: The separation medium of claim 6, wherein the spherical beads are aggregated into hierarchical structures.

9: The separation medium of claim 1, wherein the metal particles are made of Fe₃O₄, the coating of the metal particles is made of poly(divinylbenzene), the pre-functionalised beads are SOURCE™ 15Q, and the outer coating is made of agarose.

10: The separation medium of claim 6, wherein the new spherical bead diameter is 5-1000 μm.

11: The separation medium of claim 1, wherein the pre-functionalised beads and/or the outer coating is/are provided with ligands having affinity for selected biomolecules.

12: The separation medium of claim 11, wherein the ligands are selected from the group consisting of metal chelating agents, antibodies, members of affinity pairs, aptamers, hybridisation probes, charged groups or lipophilic groups.

13: The separation medium of claim 12, wherein the outer coating is made of agarose provided with metal chelating (IMAC) ligands.

14: A method of producing a separation medium comprising the following steps:
a) treating magnetic metal, metal oxide or alloy particles with an amphiphilic agent;
b) adding a polymerisable monomer and a radical initiator to the treated magnetic particles;
c) emulsifying the monomer/particle mixture in an aqueous phase and polymerising the monomer by increasing the temperature to obtain polymer-coated magnetic particles;
d) mixing the polymer-coated magnetic particles with pre-functionalised beads;
e) adding the mixture to a hydrophilic polymer;
f) emulsifying the polymer-coated magnetic particles and the pre-functionalised beads into the hydrophilic polymer; and optionally
g) attaching a ligand to the outer layer of the hydrophilic polymer, said ligand having affinity for a selected biomolecule.

15: The method of claim 14, wherein the magnetic metal oxide particles are Fe₃O₄, the chemically inert polymer is divinylbenzene, the pre-functionalised beads are SOURCE™ 15Q and the hydrophilic polymer is agarose.

16-22. (canceled)

23: The separation medium of claim 7, wherein each spherical bead comprises 10-20 coated metal particles.

24: The separation medium of claim 10, wherein the new spherical bead diameter is 20-400 μm.

25: The separation medium of claim 10, wherein the new spherical bead diameter is 50-150 μm.
